(19) United States
(12) Patent Application Publication
(10) Pub. No.: US 2002/0067855 A1
(43) Pub. Date: Jun. 6, 2002

(54) Method and arrangement for camera calibration

(76) Inventors: Ming-Yee Chiu, Princeton Junction, NJ (US); Remi Depommier, Princeton, NJ (US)

Correspondence Address: EPPING, HERMANN & FISCHER, RIDLERSTRASSE 55, MUNCHEN, BAVARIA, D-80339, DE

(21) Appl. No.: 09/912,069

(22) Filed: Jul. 24, 2001

(30) Foreign Application Priority Data
Jul. 24, 2000 (EP) 00115862.5

(51) Int. Cl. G06K 9/48

(52) U.S. Cl. 382/199

(57) ABSTRACT

An arrangement and method is set out which records a digitised image of a figure with the figure preferably comprising a black disk, which is surrounded by an arrangement of radial line segments. The method extracts edge points from the recorded image and performs a transform on the edge points to obtain a center of the figure. Then, a diameter of the disk is obtained to calculate the conversion factor, which represents the distance between the camera and the figure. The line segments may further comprise at least one bar code defining encoded information. The method provides a reliable calibration even under cluttered background conditions.

### BACKGROUND OF THE INVENTION

The present invention relates to a method and apparatus for calibrating a camera or other image recording device, wherein the camera records an information bearing figure or pattern which provides information used in calibrating.

Numerous applications exist where a camera or imaging system requires quick, easy and human error resistant field installation. One such application includes the use of a camera for automated monitoring of an analog or a digital meter. An analog meter generally has a needle and a scale, while a digital meter has digits on rotating wheels. In this type of application, the object of interest is a two dimensional (2D) display panel of the meter. The absolute dimensions of the display panel may be stored in the imaging system. However, depending upon the meter-camera field setup, the meter can appear large or small in the digitized image thereof created by the camera. Herein, a camera captures a picture of the meter and recognizes the position of the meter needle relative to the meter scale. The picture recognition algorithm of the camera must be adjusted to the specific type of meter as well as the distance between the meter and the camera. However, the input of this data by human interaction is error prone and time consuming and has given rise to the popularity of automated calibration systems and methods.

Many calibration methods use a planar 2D pattern for calibration. The calibration pattern is placed at the plane of the intended object to be monitored or otherwise recorded. The camera captures the image, locates the pattern and extracts features and information to compute the distance-to-pixel conversion factor. This parameter then refers to the absolute dimension at the object plane where the calibration pattern is placed. A commonly used pattern is a black disk on a white background, or many disks arranged in a particular pattern to extract other information such as the direction and tilt angle of the 2D pattern with respect to the camera. However, circles are quite common in the environment. When this type of calibration pattern is placed in a cluttered background, sometimes other circles are mistaken for the intended calibration pattern. Even though it is possible to reduce this error by using multiple circles (or disks) arranged in a specific pattern, the resulting calibration pattern becomes large and complex The calibration information is input to a calibration algorithm for the absolute dimension of the calibration pattern. Where numerous diverse and complex calibration patterns are employed, a larger burden of data entry and hence opportunity for (human) error arises.

In the article Tsai, Roger: “An Efficient and Accurate Camera Calibration Technique for 3D-Machine Vision”, IEEE Computer Society on Computer Vision and Pattern Recognition, 1986, pp. 364-374, a variety of camera calibration techniques are disclosed. One technique comprises a camera connected to image acquisition hardware, which is still further connected to a computer. The camera captures a picture of a predetermined fixed pattern. The pattern comprises a squared array of e.g. 4×4 rectangles.

U.S. Pat. No. 5,329,469 discloses a visual sensor calibration method using a calibration pattern of rectangularly arranged circles. One circle with a larger diameter is arranged at the corner of the rectangle, while the others maintain same sizes.

In many object recognition and industrial inspection applications, the physical dimensions and the geometrical model of the object are used extensively in the algorithm to guide the localization and recognition of the object. For objects that are 2D in nature or close to 2D (i.e., object depth is smaller than object distance (to camera)), it is necessary to know in advance the conversion factor of the physical dimension of the 2D object and the pixel distance in the imaging system. For example, if the geometric model of the object shows that the distance from feature A to feature B is 4 cm, the algorithm needs to convert this physical dimension information to the pixel units, such as 40 pixels, since the image processing algorithm works mostly in pixel units for distance. Basically, the calibration procedure for the camera derives two conversion factors, one along the x-pixel and one along the y-pixel. When the pixels are square, only one conversion parameter is needed. It can be assumed that the camera has square pixels, with, for example, a conversion factor of 0.1 cm/pixel.

### BRIEF SUMMARY OF THE INVENTION

Advantages of the present invention includes: providing an arrangement, method and figure or pattern for calibrating a camera which is easy to use and implement, provides a reliable and relatively consistent calibration, is relatively free from human error, and requires little human intervention.

These and other advantages are effected an arrangement for calibrating a camera, comprising: a camera for recording a digital image, said camera including processing means for processing said digital image and calibrating said camera according to said processing, and; a figure arranged to be recorded by said camera, said figure comprising a first portion having a continuous circular shape and a second portion with a plurality of circularly arranged spaced segments, said second portion is arranged around said first portion. The arrangement may further comprise: processing means further comprises: means for performing an edge point transformation detection of said recorded image; means for performing a Hough Transformation on said edge points; means for obtaining a radius from said first portion; and means for using said radius to provide a conversation factor representative of a distance between said camera and said figure.

These and other advantages are effected by a method of calibrating a camera, comprising the steps of: digitally recording an image of a figure, said figure comprising a first portion having a continuous circular shape and a second portion having a plurality of circularly spaced segments; extracting a set of edge points from said recorded image; performing a transform on said edge points thereby obtaining an image center point; and obtaining a diameter of said first portion to provide a conversion factor comprising a distance between said camera and said image. The method may further comprise the steps of: obtaining an intensity profile and intensity pattern of said second portion; decoding said intensity pattern to obtain data, said data representing a diameter of said first portion.

These and other advantages are effected by a figure or pattern for calibrating a camera, said figure comprising: a first portion comprising a closed filled circular element; and a second portion surrounding said first portion, said second portion comprising a plurality of dashes and spaces between said dashes, said dashes and spaces defining a bar code, The figure may further comprise said first portion and said second portion applied onto a background and said first portion and second portion contrast said background.

The present method performs a transform to locate the center of the pattern. In general, any suitable transform that transforms a set of edge points to obtain a center would be suitable. When the center of the patterns' radial line is circular and known, the diameter of the first portion can be detected. The figure preferably comprises a first portion comprising black continuous circle, encircled by the second portion comprising spaced apart segments. Such segments are a portion of a radial line that starts at the pattern center and extends outwardly. In general only the portion outside of the black circle appears on the figure. The first and second portions have the same center. When the diameter of the disk is measured by the camera and is compared with the known predetermined actual diameter of the disk, the conversion factor, which is representative of the distance between the camera and the figure, can be calculated. For example, when the figure in a second position is more distant from the camera as compared to a first position, the disk appears smaller in the camera plane in the second position than in the first position. The conversion factor is the actual physical dimension of the disk (e.g. 5 cm) divided by the computed diameter of the disk in the digitised camera plane (e.g. 25 pixels). In this example, the conversion factor is 0,2 cm/pixel.

The diameter of the disk can be fixed. Alternatively, disks of different figures can be of different size with the respective diameter being encoded into the segments surrounding the disk. The calibration program obtains an intensity profile of the arrangement of segments and decodes the diameter. The conversion factor is calculated depending on the decoded diameter, which represents the actual size of the disk. This embodiment supports the use of various figures with different feature sizes, so that a larger sized figure can be used when the figure is placed in a larger distance from the camera and a smaller sized figure can be used when the figure is placed closer to the camera.

The code which is employed to encode the diameter into the arrangement of segments may be a bar code type arrangement which represents numerals, characters and/or alphanumerical characters by bars of different length and spacing therebetween. The invention may use circular arrangement of bars representing an intensity profile through the segments corresponding to a linear well-known bar code system.

The information encoded in the radial line segments may further comprise control information, which is used to control the further performance of the camera. For example, after the completion of the camera calibration, further images are recorded and evaluated by a picture recognition algorithm within the camera. One application of the camera is in the field of analog or digital meter reading, where the actual value of the meter is determined by the picture recognition algorithm. The control information, which is encoded in the radial line segments, may comprise the type of the meter to be read, an identity code of the owner of the meter or an identity code, e.g. URL-internet address or telephone number of the service provider of the meter reading system. In all conceivable applications, the further processing of any image recorded after the camera calibration is influenced and controlled by the control information encoded in the radial line segments.

The circular bar code is arranged between an inner and an outer radius with respect to the center of the figure. To enhance the amount of data to be encoded, a further circular bar code arrangement can surround the first bar code arrangement. Thereby, the inner radius of the further circular bar code arrangement is equal or larger than the outer radius of the first circular bar code arrangement. The further bar code is decoded according to the same principle as the first bar code arrangement by obtaining an intensity profile along a circle within the radial line segments of the further bar code arrangement.

When the figure is viewed from an oblique angle, e.g. not perpendicular to the center of the figure, circles appear as ellipses. To decode information from the figure, the recorded image is subjected to a linear transformation, which transforms the image into a plane standing normal to the distance between the camera and the center of the figure. The transformed image appears to be viewed normally by the camera.

A Hough Transform may be performed in a known way. Edge points as well as edge gradients are obtained from the recorded image. A vote line extends orthogonal to the edge gradient at the edge point with a vote line segment in a distance of a radius starting at the edge point. The vote lines are accumulated. The accumulated vote lines result in a maximum at the center of the circle, which corresponds to the arrangement of the radial line segments. To obtain flexibility, the radius may not be known to the camera. In this case, ranges of radii are defined, which overlap each other. In particular, each range of radii is defined between a major and a minor radius, whereby the minor radius of one range is smaller than the major radius of another range, i.e. both ranges overlap each other.

The Hough Transform provides a reliable detection and determination of the center of the calibration figure. Even under cluttered background with multiple intensity variations conditions, it is very unusual that a pattern according to the invention is present in the field of vision of the camera. Therefore, the method provides a reliable recognition of the figure even under cluttered background.

The present method and arrangement may also be used to perform, automatically, running camera calibration under cluttered environment conditions and without any need for human input. There is no pre-assumption: on how far the calibration pattern is placed; on the magnitude of the tilt angle with respect to the camera; and on the size of the pattern being presented. The same pattern is used to determine precisely the center of the pattern for localization purpose. As an advantage, additional information can be encoded into the same calibration pattern for controlling the operation of the system or for other purposes. The present invention allows the placement of the calibration pattern of any size on the face of the meter and the meter reading can start immediately without any error prone human input.

The present method may also be used for other applications in such a way that each individual pattern is encoded with an identification (ID) number. For example, the multiple patterns can be placed in a large room to calibrate physical dimension in many different planes in the room. When the plane to be calibrated is far from the camera, a larger pattern can be used so that its image remains large enough to be analyzed. The system knows what is the absolute dimension automatically. Since each pattern has its own ID, it can be identified uniquely.

An additional advantage of the present invention includes a camera and signal processing device connected to the camera which may be provided with any arbitrary control information. For example, if the camera is the input device for a meter reader all information about e.g. the type of meter to be read, the location of the meter, etc. can be input to the reader. Especially, when the reader has a communication interface which transmits the data read to a host, the telephone number of the service provider or other URL (uniform resource locator) address for Internet connections can be encoded into the pattern to eliminate the need of human input.

### BRIEF DESCRIPTION OF THE SEVERAL VIEWS OF THE DRAWINGS

Some of the features, advantages, and benefits of the present invention having been stated, others will become apparent as the description proceeds when taken in conjunction with the accompanying drawings wherein corresponding elements are denoted by like numerals.

The drawings depict:

FIG. 1 depicts a calibration figure or pattern;

FIG. 2 depicts a flowchart of calibration steps;

FIG. 3 depicts vote accumulation of Generalized Hough Transform for Radial Line Segments;

FIG. 4 depicts the division of a radius range into multiple radii pairs for multiple Generalized Hough Transforms;

FIG. 5 depicts a variation of the calibration pattern; and

FIG. 6 depicts an arrangement according to the present invention.

### DETAILED DESCRIPTION OF THE INVENTION

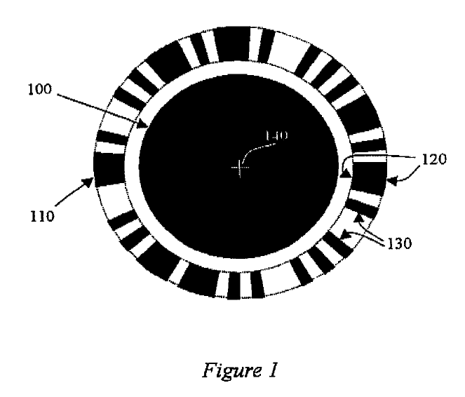

FIG. 1 depicts a calibration figure or pattern, herein referred to by it's possible tradename “Sunshiny”, comprising a first and second pattern. The first or inner pattern 100 comprises a black circular disk. The second or outer pattern 110 comprises a set of bars and spaces arranged in a circle. The outer pattern may be one or more linear bar codes arranged in a circular path. Information, including the diameter of the circular disk 100, can be encoded in this outer pattern 110. The boundary of the bar and space elements is bounded by two circles 120 from the top and the bottom, and from the side by a set of radial lines 130. The center of two bounding circles 120 coincides with the center 140 of the disk 100. Most all radial lines 130, when extended, intercept at center 140. The radial lines 130 are used to locate the center 140 of the Sunshiny pattern. The center of the disk and the center of the arrangement of the radial line segments are the same. The diameter of disk 100 is used to compute the distance-to-pixel conversion, using the absolute diameter information decoded from the bars and/or spaces code in outer pattern 110. The present algorithm may derive the tilt angle of the pattern with respect to the camera since the disk pattern 100 will appear as an ellipse if it is viewed from an oblique angle.

The circular bar code in sub-pattern 110 differs from the traditional linear bar code in that the circular bar code is in a wrap-around pattern. Therefore, only a start pattern of the code is needed if the bar code is scanned always in one circular direction. For example, if code 39 symbology is used, then instead of using the character * (a binary word encoded as 010010100) for both start and the stop characters, only one * character may be used for the circular bar code. The bar code encodes numerals, characters, or alphanumeric information as known to one skilled in the art.

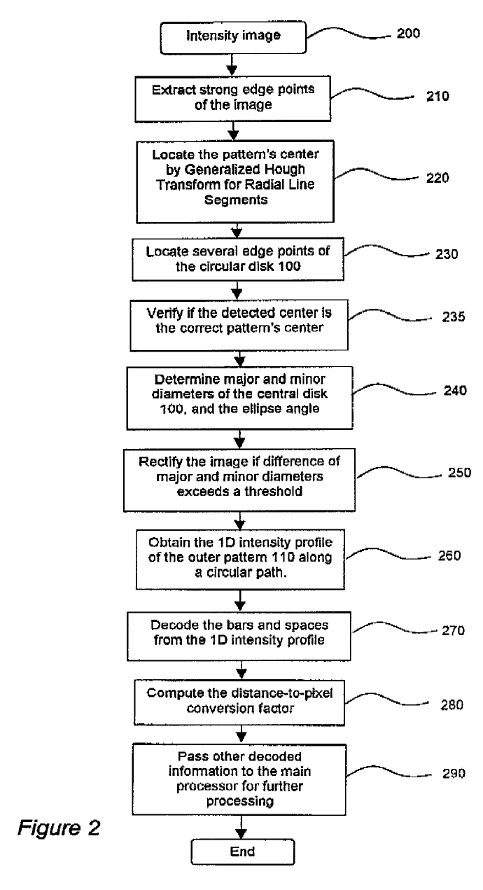

FIG. 2 depicts a flow chart of calibration steps according to an algorithm of the present invention. The input of the intensity image 200 is the Sunshiny pattern captured from the camera. The image is a 2D array indexed by the x-pixel and y-pixel coordinates. All computations related to distance measurement are expressed in pixel unit step 280 where the absolute physical distance unit, such as centimeter, is needed for the conversion factor. Step 210 performs two 3×3 Sobel operations in the x- and y-direction to extract the x-gradient and y-gradient of the image. By computing the magnitude of the gradient, which is the square root of the sum of the square of the x- and y-gradients, a gradient magnitude image whose intensity representing the strength of the edginess of the original image, is obtained first. Then those points whose gradient magnitude exceeding a threshold, called “strong edge points”, are identified. For black and white design pattern like Sunshiny, the edge gradient is usually high compared to that from the background.

Step 220 uses a method Generalized Hough Transform (GHT) for Radial Line Segments (RLS) to locate the center of the Sunshiny pattern. This technique is also used for the recognition of the center of a graduation scale of an analog meter.

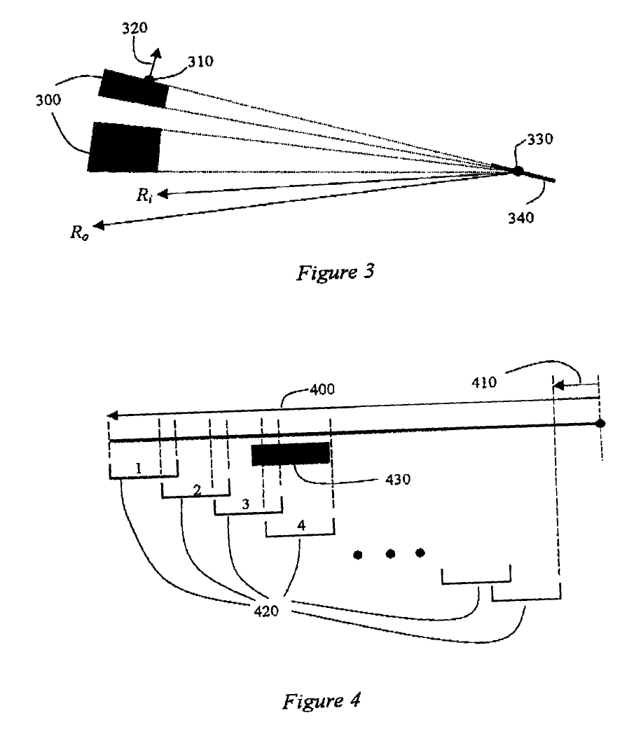

Briefly referring to FIG. 3, the strong edge points extracted from step 210 will be located around the boundary of the black bar elements 300 of the outer pattern 110. Because of the construction of the bar pattern, all the radial edge lines point to the center 330 of the pattern, which is the same as point 140 in FIG. 1. Only a strong edge point 310 is considered whose x- and y-gradient is a vector 320 normal to the boundary of the bar element. If the innermost radius Ri and the outermost radius Ro of the radial edge lines are known, then for each strong edge point 310, a uniform line of votes 340 on a parameter plane “vote accumulation plane” is deposited. This line of votes is normal to the gradient direction 320 and located at a distance of Ri to Ro from the point 310. Additionally, another line of vote (not shown in FIG. 3) at the opposite side of the point 310 will also be deposited. This is because it is not known which side the pattern center will be located at this point. For other strong edge points on the same radial edge line, the line of votes will be shifted slightly depending on the position of the strong edge point. The resultant accumulation is a triangular shape vote line centered at the pattern center 330. If the process is repeated for other radial edge points of the bar patterns, the vote accumulation will create a strong peak at the center of the pattern 330, which is the same as point 140. For the vote lines on the other side of the edge points, it will not create any peak since the vote lines are spread over a large circle. The strong peak in the vote accumulation plane is almost always caused by the radial line segments which are arranged in circular shape. For other strong edge points generated from step 210, including edge points from circles or disks, the vote line will be spread over a large area. Therefore by detecting the peak in the vote accumulation plane, the center of the Sunshiny pattern can be uniquely determined. The center accumulation is strong since there are many radial edges points in the outer bar code pattern 110. This is a reason why the Sunshiny pattern can be easily detected under the cluttered background that may consist of many circles and straight lines.

It is to be noted that this Generalized Hough Transform also works when the outer bar code pattern 110 appears as an elliptical shape. This is the case when the Sunshiny pattern is viewed at an oblique angle. All radial edges lines still point to the center of the pattern when viewed obliquely.

The radii Ri and Ro (in pixel unit) are not known in general. The outer bar code pattern 110 can be of any arbitrary size in the image. Therefore, there is a need to compute multiple vote accumulation planes for all possible radii pairs Ri and Ro. Since the entire Sunshiny pattern needs to be in the field of view of the image, the maximum outer radius Ro possible is half the height of the image, assuming the width of the image is larger than the height of the image. The minimum inner radius can be a small value where the pattern has enough resolution for analysis. Briefly referring to FIG. 4, from the maximum radius 400 and minimum radius 410, N sets of radii pairs 420 can be computed with some overlapping between two neighboring pairs. A typical value for overlapping is 25% of the radial range. Each radii pair is used to compute the Generalized Hough Transform of the vote accumulating plane corresponding to that radii pair.

Depending on the width of the circular bar code pattern 110, and the size of the entire pattern in the image plane, and the number of divisions of the radius N, the peak can be located in one, two or even three vote accumulation planes. The vote plane with the maximum peak will be selected for computing the center of the Sunshiny pattern. For better accuracy, the center 140 can be determined by computing the centroid of the votes on the selected vote accumulation plane. For example, if the bar element 430 of the outer pattern 110 lies in the #3 and #4 radii pairs as shown in FIG. 4, then both vote accumulation planes #3 and #4 will have vote lines like 340 from different radial edge points intercepting at the pattern's center 330 and therefore creating a peak there. However, because the number of radial edge points contributing to the peak on the #4 plane is more than that on the #3 plane, the peak in #4 vote accumulation plane would be used to determine the centroid of the pattern's center.

Returning to FIG. 2, with the center of the pattern computed, step 230 then locates a set of edge points on the boundary of the circular disk 100. This is done by checking the gradient magnitude of the image along a radial line outward from the pattern's center 140. Usually the gradient magnitude will be very small until it reaches the boundary of the disk 100 where the gradient magnitude will become large and reach a local maximum. The coordinate of this local maximum and the radius of this boundary point are then recorded. This is repeated for 8 or 16 regular angles over the entire 360 degrees. Therefore a set of 8 or 16 boundary points of the black disk is obtained.

Step 235 verifies that if the pattern's center determined from the outer sub-pattern 110 is indeed located inside the inner circular disk 100. Even though the radial line pattern is rarely seen in a typical environment, there is still a very small possibility that a wrong center is detected. However, the combination of a set of radial line pattern and a black disk (which is an elliptical disk when viewed obliquely) inside is not very common. To verify if the pattern's center is the right one, one method is to check if the radii extracted from step 230 differs within a certain limit. For example, if the maximum viewing angle of the Sunshiny pattern allowed is 45 degrees, then the minimal radius of the elliptical disk is cos(45°)=0.707 times the maximal radius. Therefore if, for example, the range (i.e., maximum minus minimum) of the radii obtained from step 230 is greater than 0.8 times the maximum radius, then the system can conclude that the pattern's center detected by step 220 is not correct and thus no Sunshiny pattern is detected. Another simple method is to check if the maximum gradient magnitude in a small region centered on the pattern's center is very small. The size of this check region can be determined from the minimal size allowed for the Sunshiny pattern.

Step 240 computes the properties of the disk 100 from the locations of the extracted boundary points. In general, the disk 100 appears as an ellipse in the image when the disk is viewed in an oblique angle. By fitting an ellipse to the boundary points, the major and minor diameters and the angle of the ellipse can be determined. When the major and minor diameters are the same, it is an indication that the Sunshiny pattern is viewed normally. This diameter, which is in pixel units, will be used in step 280 to compute the distance-to-pixel conversion factor.

Step 250 is performed only if the difference between major and minor diameters exceeds a threshold. This is the case when the camera views the Sunshiny pattern at an oblique angle. Step 250 makes a linear transformation of the original image so that the original image becomes a normally viewed image. First, the image is rotated with a negative of the ellipse angle computed from step 240. Then it is re-sampled along the minor axis, which now coincides with the image y-axis, so that, after re-sampling, the value of the minor diameter is the same as the major diameter. Essentially, the image along the y-axis is stretched. The entire pattern, which was in elliptical shape, is now rectified into a circular shape, including the circular bar code pattern. The rectified image is that image which would be viewed when the figure would stand in a plane which is normal to the distance between the camera and the center of the Sunshiny pattern.

The procedure used in step 250 to rectify the image will also be used during the actual run of the object recognition algorithm since the conversion parameter derived in 280 later is valid only for the same image rectification procedure. The situation of oblique view can happen in real application because sometimes the condition in the field does not allow normal viewing of the object to be recognized. In this case, the Sunshiny pattern is placed on the same plane of the object, such as the display panel of the meter, during the calibration procedure.

The next step is to decode the information from the bar code sub-pattern 110. This sub-pattern contains the value of the physical diameter of the disk 100 in units of centimeters for example. The bar code may include information relating to another figure, object, wall or the like. The Sunshiny pattern may further be affixed to that referred to by the bar code and the pattern may also comprise means for affixing to that referred to. The bar code may include calibration information, contact information to a host or other, contact means information including URL address, telephone number, address, and the like. The bar code may further comprise other relevant information for calibration including detailed information regarding that which the Sunshiny pattern is affixed to, distance information, and the like. The bar code is not limited as to the type of information encoded therein but for the imagination of one skilled in the art. The design of the Sunshiny pattern is that there is a fixed ratio between the mid radius of the outer bar code pattern 110 and the radius of the circular disk 100. Knowing the radius of the disk by step 230, the mid radius of the bar code pattern can be computed in step 260. Then using this mid-radius, a ID intensity profile of the bar code can be “scanned” by sampling the intensities, either from the original image or from the rectified image, along a circular path.

Step 270 then decodes the ID circular bar code pattern. This is similar to known decoding procedure from the bar code industry. As mentioned earlier, the difference is that here the ID intensity profile is a wrap-around function. The decoding process can be done by first recognizing the start character of the code. The rest in a similar manner to that which is known for linear bar code decoding procedures.

The information encoded in pattern 110 has the value of the physical diameter of the circular disk 100, and if needed the unit of the dimension used (cm or inch etc.) Step 280 uses this information to compute the conversion factor by dividing this physical diameter by the diameter of the disk in pixel unit, derived in step 240 or 250.

If there are other parameters encoded in the circular bar code pattern, step 290 passes these parameters to the main program for further processing. The bar code comprises codes for numerals, characters and alphanumeric information.

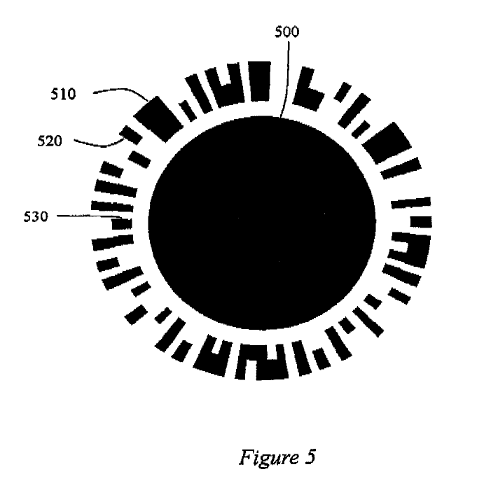

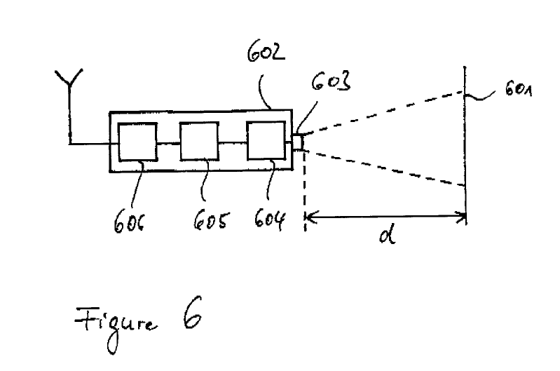

One variation of the preferred embodiment is to use multiple stacked bar codes to increase the amount of encoded information. An example is shown in FIG. 5, the outer sub-pattern 510 has two stacked bar codes 520 and 530. The ratios of the mid-radii of both circular bar codes to the radius of the central disk 500 are fixed. The algorithm flow as shown in FIG. 2 is the same except that in steps 260 and 270, multiple bar code profile extraction and multiple bar code decoding are performed. The detection of the start character of the bar code needs only be done once if all stacked bar codes share the same start character. It is to be noted that the Generalized Hough Transform for Radial Line Segments remains as effective when multiple stacked bar codes are used. This is because that the vote contribution to the pattern's center only depends on the number of radial edge points pointing toward the center, independent of the angular location of the radial edge points, as long as these edge points point toward the same center.

FIG. 6 depicts an arrangement according to the present invention. Herein, the Sunshiny pattern 601 stands within the field of vision of a camera 602. The Sunshiny pattern can be any of the patterns of FIG. 1 and FIG. 5. The pattern 601 is located at a distance d from the camera. The camera 602 has a lens system 603, which projects the captured image onto a CCD element 604. A processor 605 programmed to or otherwise made to perform the Hough Transform including the edge point detection and the radius detection of the disk of the Sunshiny pattern as well as other processing discussed above. In addition, a communication device 606 communicates any information to a central host system, when the camera reads a digital or analog meter in an automatic meter reading system or other application. Preferably, the communication device 606 is a wireless communication module of a cellular telephone system, which may communicate to the host system via an Internet protocol or a dial-up communication.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An arrangement for calibrating a camera, comprising:
a camera for recording a digital image, said camera including processing means for processing said digital image and calibrating said camera according to said processing, and;
a figure arranged to be recorded by said camera, said figure comprising a first portion having a continuous circular shape and a second portion with a plurality of circularly arranged spaced segments, said second portion is arranged around said first portion, said second portion arranged around said first portion.

2. The arrangement according to FIG. 1, wherein said processing means further comprises:
means for performing an edge point transformation detection of said recorded image;
means for performing a Hough Transformation on said edge points;
means for obtaining a radius from said first portion; and
means for using said radius to provide a conversation factor representative of a distance between said camera and said figure.

3. The arrangement according to claim 1, wherein said first portion comprises a disk and said second portion comprises at least one circularly arranged bar code.

4. The arrangement according to claim 3, wherein said bar code includes encoded control information used in said calibrating.

5. The arrangement according to claim 3, wherein said bar code includes encoded information related to another figure.

6. The arrangement according to claim 3, wherein said bar code includes an encoded telephone number.

7. The arrangement according to claim 3, wherein said bar code includes an encoded URL address.

8. The arrangement according to claim 3, wherein said second portion comprises two stacked circularly arranged bar codes each comprising different encoded information.

9. The arrangement according to claim 1, wherein said camera further comprises communication means for transmitting data to a remote host.

10. The arrangement according to claim 9, wherein said remote host is identified in said second portion.

11. The arrangement according to claim 9, wherein said communication means communicates via a dial up communication.

12. A method of calibrating a camera, comprising the steps of:
digitally recording an image of a figure, said figure comprising a first portion having a continuous circular shape and a second portion having a plurality of circularly spaced segments;
extracting a set of edge points from said recorded image;
performing a transform on said edge points thereby obtaining an image center point; and
obtaining a diameter of said first portion to provide a conversion factor comprising a distance between said camera and said image.

13. The method according to claim 12, further comprising the steps of:
obtaining an intensity profile and intensity pattern of said second portion;
decoding said intensity pattern to obtain data, said data representing a diameter of said first portion.

14. The method according to claim 13, further comprising the step of transmitting image information to a remote host, and wherein said data comprises remote host contact information.

15. The method according to claim 14, wherein said data comprises information concerning a second figure, and further comprising the steps of:
attaching said figure to said second figure;
digitally recording said second figure; and
transmitting said digitally recorded second figure to a remote host.

16. The method according to claim 12, further comprising the steps of:
determining a radius of said first portion by obtaining a first portion edge point and obtaining a first portion intensity profile using said first portion edge point and said center point.

17. The method according to claim 16, further comprising the steps of:
performing a linear transformation of said image into a plane normal to said camera and said center point; and
obtaining at least two radii of said first portion.

18. The method according to claim 12, wherein said plurality of segments define a major and minor radius to said center point and edge gradients, and further comprising the steps of:
obtaining a vote line in a direction orthogonal to at least one edge gradient, said vote line having a length between said major and minor radius;
determining an intersection of said vote lines, said intersection representing an image center point.

19. The method according to claim 12, wherein said segments define at least one circular bar code.

20. The method according to claim 19, wherein said segments define two stacked bar codes.

21. The method according to claim 19, wherein said bar codes comprise encoded information related to a host, and further comprising the step of transmitting data related to said figure to said host.

22. The method according to claim 21, wherein said data is transmitted via a dial up communication.

23. The method according to claim 19, wherein said figure is affixed to a second figure, said bar code comprises encoded information related to said second figure and said transmitted data comprises data related to said second figure.

24. The method according to claim 23, wherein said camera comprises programming means and further comprising the step of programming said camera to periodically calibrate with said figure.

25. The method according to claim 12, wherein said transform is a Hough Transform.
